(19) United States
(12) Patent Application Publication
(10) Pub. No.: US 2016/0133114 A1
(43) Pub. Date: May 12, 2016

(54) TEMPERATURE MONITORING SYSTEM AND METHOD OF USING THE SAME

(71) Applicants: HONG FU JIN PRECISION INDUSTRY (Shenzhen) CO., LTD., Shenzhen (CN); HON HAI PRECISION INDUSTRY CO., LTD., New Taipei (TW)

(72) Inventor: KE-YOU HU, Shenzhen (CN)

(21) Appl. No.: 14/556,437

(22) Filed: Dec. 1, 2014

(30) Foreign Application Priority Data
Nov. 10, 2014 (CN) 201410624938.0

(51) Int. Cl. G08B 21/18

(52) U.S. Cl. CPC G08B 21/182

(57) ABSTRACT

A temperature monitoring system includes a detection module, a control module with a predetermined temperature value, and a display module. The detection module is configured to detect and generate an actual temperature value. The control module is configured to compare the actual temperature with the predetermined temperature value. The display module coupled to the detection module via the control module, and is configured to display the actual temperature value. When the control module identifies the actual temperature value is greater than the predetermined temperature value, the display module is controlled by the control module to display an alert indicator. The present disclosure further discloses a temperature monitoring method.

### FIELD

The subject matter herein generally relates to temperature monitoring systems and temperature monitoring methods using the same.

### BACKGROUND

It is necessary to measure the temperature of the environment parameter for each workshop. Usually, the temperature is measured manually with temperature sensing elements.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a block diagram of an embodiment of a temperature monitoring system.

FIG. 2 is a diagrammatic view of a detection module, a control module, and an alarm module of the temperature monitoring system of FIG. 1.

FIG. 3 is a diagrammatic view of a switch module and an interface of a display module of the temperature monitoring system of FIG. 1.

FIG. 4 is a flow chart of a temperature monitoring method in accordance with an embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein. It should be noted that references to “an” or “one” embodiment in this disclosure are not necessarily to the same embodiment, and such references can mean “at least one.”

Several definitions that apply throughout this disclosure will now be presented.

The term “coupled” is defined as connected, whether directly or indirectly through intervening components, and is not necessarily limited to physical connections. The connection can be such that the objects are permanently connected or releasable connected. The term “comprising” means “including, but not necessarily limited to”; it specifically indicates open-ended inclusion or membership in a so-described combination, group, series and the like.

The present disclosure is described in relation to a temperature monitoring system. The temperature monitoring system includes a detection module, a control module with a predetermined temperature value, and a display module. The detection module is configured to detect and generate an actual temperature value. The control module is configured to compare the actual temperature with the predetermined temperature value. The display module is coupled to the detection module via the control module, and is configured to display the actual temperature value. When the control module identifies the actual temperature value is greater than the predetermined temperature value, the display module is controlled by the control module to display an alert indicator. The present disclosure further discloses a temperature monitoring method.

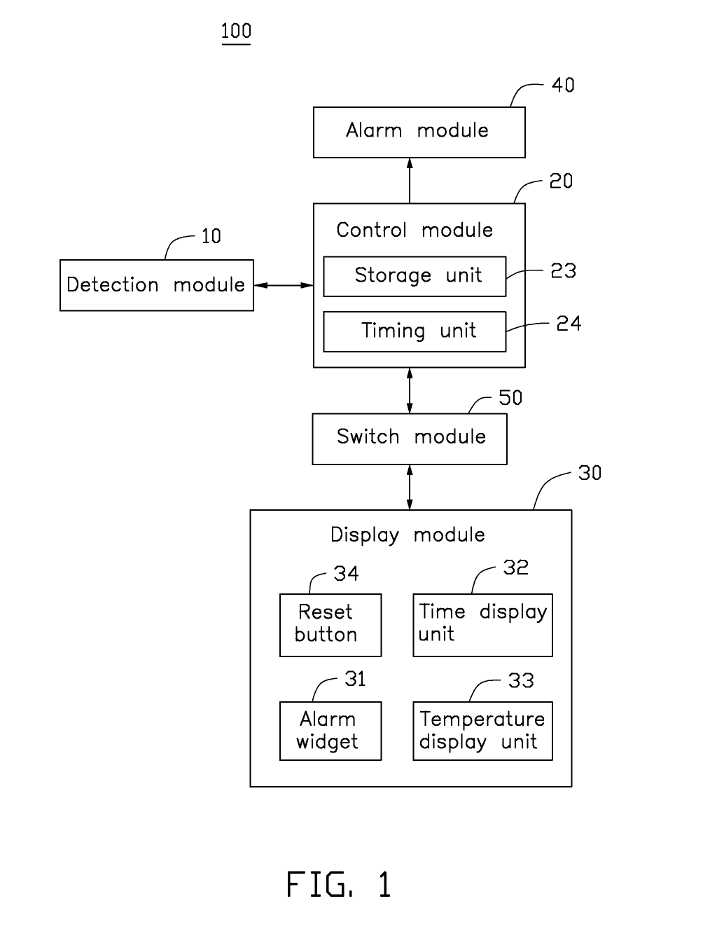

FIG. 1 illustrates an embodiment of a temperature monitoring system 100. The temperature monitoring system 100 includes a detection module 10, a control module 20 with a predetermined temperature value (such as 30 degrees), a display module 30, and an alarm module 40. The detection module 10 is configured to instantaneously detect and generate an actual temperature value. The control module 20 is configured to compare the actual temperature value with the predetermined temperature value. The display module 30 is coupled to the detection module 10 via the control module 20, and is configured to display the actual temperature value. When the control module 20 identifies the actual temperature value is greater than the predetermined temperature value, an alarm signal is transmitted from the control module 20 to the display module 30, and a control signal is transmitted from the control module 20 to the alarm module 40 synchronously. When the control module 20 identifies the actual temperature value is less than or equal to the predetermined temperature value, a normal signal is transmitted from the control module 20 to the display module 30. The display module 30 is controlled by the alarm signal to display an alert indicator and is controlled by the normal signal to display a normal indicator. The alarm module 40 is controlled by the control signal to sound alarm.

In at least one embodiment, the control module 20 includes a chip U1, the detection module 10 includes a chip U1, and the display module 30 includes display equipment (not shown). The chip U1 is a STC89C52single chip micro controller, and the chip U1 is a DS18B20 chip.

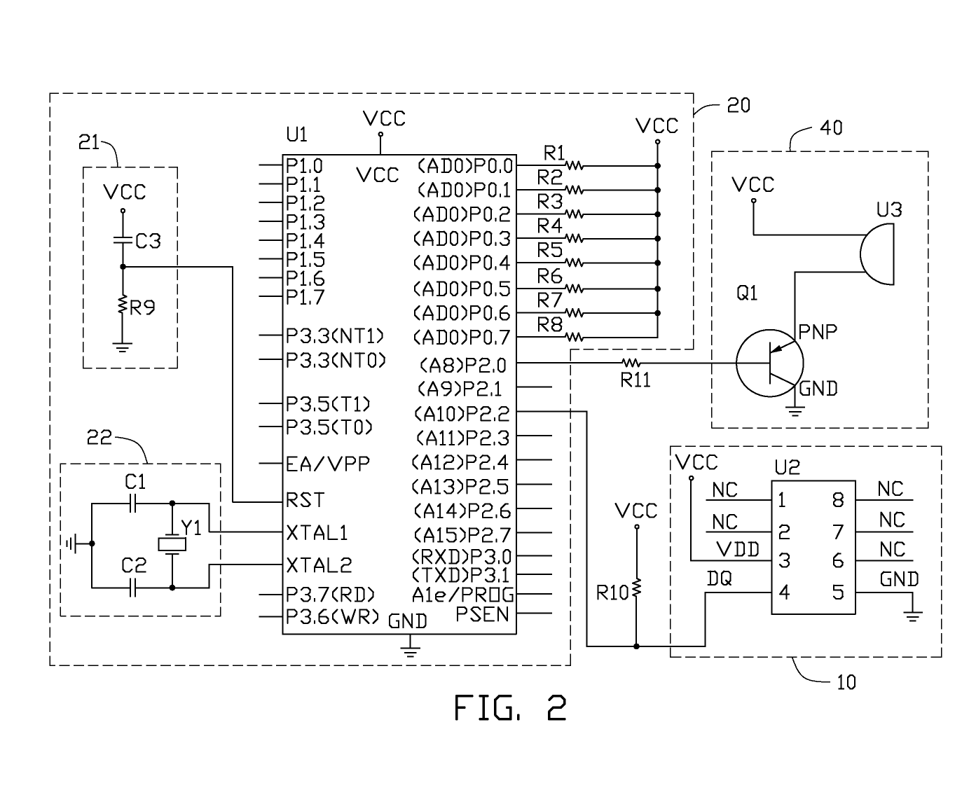

FIG. 2 illustrates the chip U1 includes a pin DQ for outputting the actual temperature value. A pull-up resistor R10 is coupled to the pin DQ.

The control module 20 includes a time-delay circuit 21 and an oscillating circuit 22. The time-delay circuit 21 is configured for time delaying and resetting, and the oscillating circuit 22 is configured for controlling an instruction cycle of the control module 20. The time-delay circuit 21 is coupled to a pin RST of the chip U1. The oscillating circuit 22 is coupled to a pin XTAL1 and a pin XTAL2 of the chip U1. In at least one embodiment, the time-delay circuit 21 is a RC time-delaying circuit. In another embodiment, the oscillating circuit 22 includes a crystal oscillator Y1. A pin P2.2 of the chip U1 is coupled to the pin DQ of the chip U2 for receiving the actual temperature value.

The alarm module 40 includes a switch Q1 coupled to a pin P2.0 of the chip U1 and a buzzer U3 coupled to the switch Q1. The control signal is transmitted from the control module 20 to the switch Q1 via the pin P2.0. The switch Q1 is switched on/off by the control signal. The buzzer U3 for sounding alarm is turned on/off by the switch. Thereby, the buzzer U3 is controlled by the control signal to buzz.

In at least one embodiment, the switch Q1 is a PNP type transistor. A base of the transistor is coupled to the control module 20, an emitter of the transistor is coupled to the buzzer U3, and a collector of the transistor is grounded.

In at least one embodiment, the buzzer U3 can be replaced by a bell or other sound equipment.

In at least one embodiment, a limiting resistor R11 is coupled between the control module 20 and the switch R11, to limit the electric current from the control module 20 to the alarm module 40.

FIG. 1 illustrates that the control module 20 further includes a storage unit 23 and a timing unit 24 for measuring time. The storage unit 23 is configured to store the plurality of actual temperature values generated by the detection module 10 during a time frame. The display module 30 is configured to display the time and the corresponding actual temperature value synchronously. Any of the actual temperature values stored in the storage unit 23 is recalled and displayed on the display module 30 by the control module 20.

In at least one embodiment, each pin P0.0-P0.7 of the chip U1 is coupled to each of the pull-up resistors R1-R8.

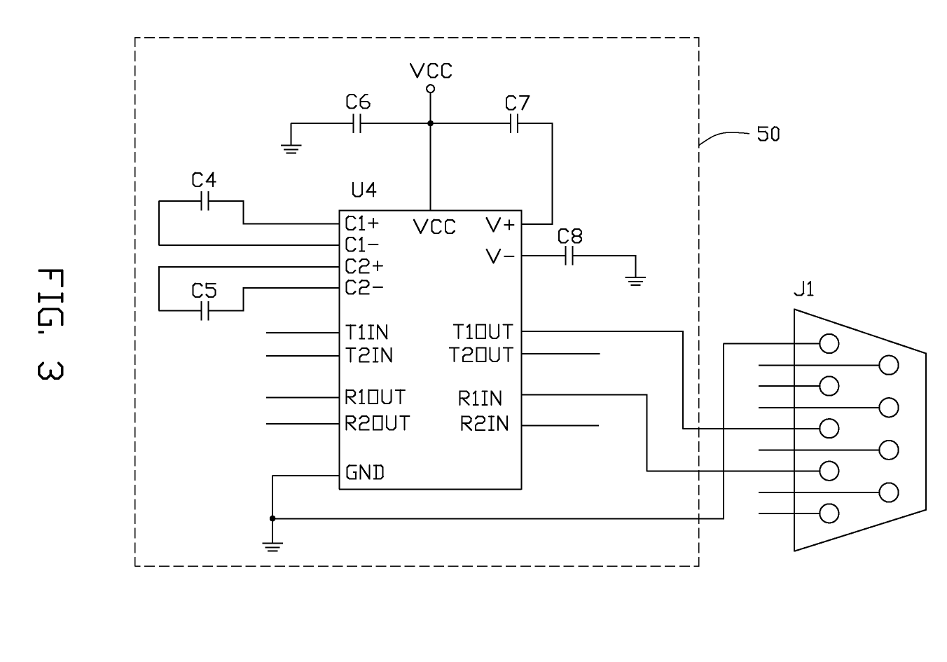

FIGS. 2-3 illustrate that in at least one embodiment, the display module 30 is a computer with an interface J1 (only J1 shown in FIG.3). The control module 20 is coupled to the computer via a switch module 50. The control module 20 is configured to communicate with the computer via the switch module 50. The switch module 50 includes a chip U4. A pin P3.0 of the chip U1 is coupled to a pin R1OUT of the chip U4, and a pin P3.1 of the chip U1 is coupled to a pin T1IN of the chip U4. A pin R1IN of the chip U4 is coupled to a pin 2 of the interface J1, and a pin T1OUT of the chip U4 is coupled to a pin 3 of the interface J1. In one embodiment, the chip U4 is a MAX 232chip, and the interface J1 is a DB9serial communication interface.

FIG. 1 illustrates that the display module 30 includes an alarm widget 31 for displaying the alert indicator and the normal indicator, a time display unit 32 for displaying time, a temperature display unit 33 for displaying the actual temperature value, and a reset button 34. The alarm widget 31 is configured to respond to the alarm signal and display the alert indicator, and to respond to the normal signal and display the normal indicator. In at least one embodiment, the alert indicator is a red indicator, and the normal indicator is a green indicator. The reset button 34 is configured to reset the timing unit 24. In at least one embodiment, the user interface of the display module 30 is formed by MSCOMM widgets of Visual Basic.

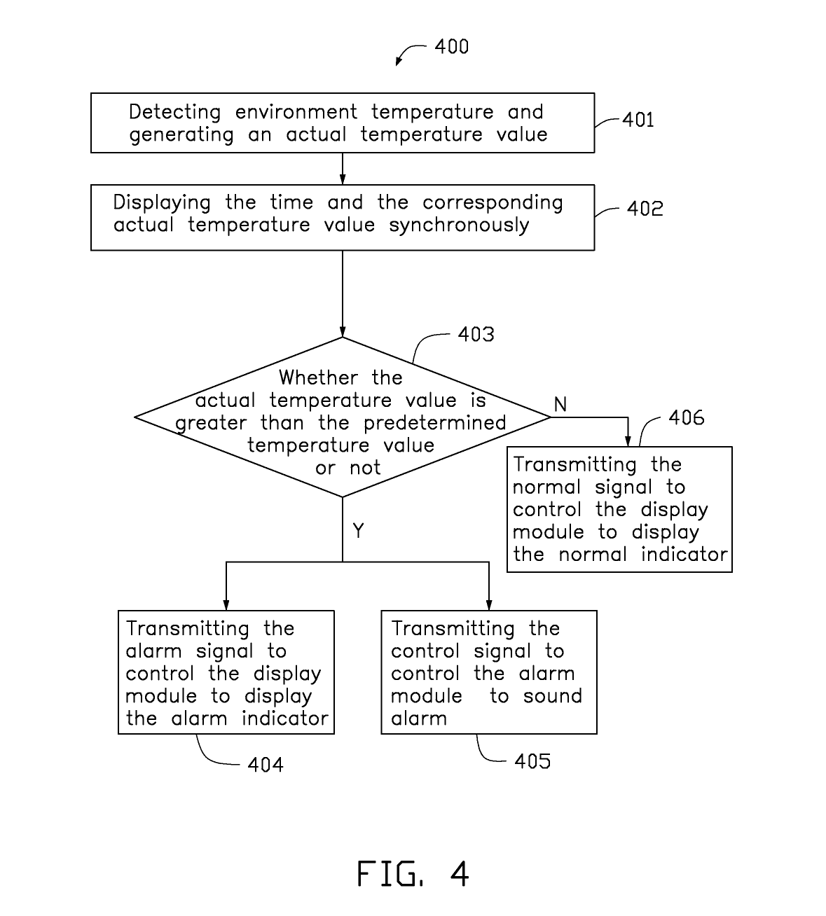

Referring to FIG. 4, a flowchart is presented in accordance with an example embodiment. The example method 400 is provided by way of example, as there are a variety of ways to carry out the method. The method 400 described below can be carried out using the configurations illustrated in FIGS. 1-3, for example, and various elements of these figures are referenced in explaining example method 400. Each block shown in FIG. 4 represents one or more processes, methods or subroutines, carried out in the example method 400. Furthermore, the illustrated order of blocks is illustrative only and the order of the blocks can change according to the present disclosure. Additional blocks can be added or fewer blocks may be utilized, without departing from this disclosure. The example method 400 can begin at block 401.

At block 401: the detection module 10 detects environment temperature and generates an actual temperature value.

At block 402: the display module 30 displays the time and the corresponding actual temperature value synchronously.

At block 403: the control module 20 compares the actual temperature value with the predetermined temperature value; if the actual temperature value is greater than the predetermined temperature value, go to block 404 and block 405, and if the actual temperature value is less than or equal to the predetermined temperature value, go to block 406.

At block 404: the control module 20 transmits the alarm signal to control the display module 30 to display the alert indicator.

At block 405: the control module 20 transmits the control signal to control the alarm module 40 to sound alarm.

At block 406: the control module 20 transmits the normal signal to control the display module 30 to display the normal indicator.

Block 402 and block 403 are executed synchronously, and block 404 and block 405 are executed synchronously.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A temperature monitoring system comprising:
a detection module configured to detect and generate an actual temperature value;
a control module storing a predetermined temperature value, and configured to compare the actual temperature with the predetermined temperature value; and
a display module coupled to the detection module via the control module, and configured to display the actual temperature value;
wherein when the control module identifies the actual temperature value is greater than the predetermined temperature value, the display module is controlled to display an alert indicator by the control module.

2. The temperature monitoring system of claim 1, further comprising an alarm module coupled to the control module; wherein when the control module identifies the actual temperature value is greater than the predetermined temperature value, the alarm module is controlled by the control module to sound alarm.

3. The temperature monitoring system of claim 2, wherein the alarm module comprises a switch coupled to the control module, and the switch is switched on/off by the control module.

4. The temperature monitoring system of claim 3, wherein the alarm module further comprises a buzzer for alarming, the buzzer is coupled to the switch and is turned on/off by the switch.

5. The temperature monitoring system of claim 4, wherein the switch is a transistor; a base of the transistor is coupled to the control module, an emitter of the transistor is coupled to the buzzer, and a collector of the transistor is grounding.

6. The temperature monitoring system of claim 2, wherein a limiting resistor is coupled between the control module and the alarm module, to limit the electric current from the control module to the alarm module.

7. The temperature monitoring system of claim 2, wherein the control module comprises a timing unit for measuring time; and the display module displays the time and the actual temperature value synchronously.

8. The temperature monitoring system of claim 7, wherein the control module further comprises a storage unit for storing the actual temperature value.

9. The temperature monitoring system of claim 1, wherein the display module comprises an alarm widget for display the alert indicator.

10. The temperature monitoring system of claim 1, further comprising a switch module coupled between the control module and the display module, and the control module is configured to communicate with the display module via the switch module.

11. A temperature monitoring method comprising:
detecting environment temperature and generating an actual temperature value;
displaying the actual temperature value;
comparing the actual temperature value with a predetermined temperature value; and
displaying an alert indicator when the actual temperature value is greater than the predetermined temperature value.

12. The temperature monitoring method of claim 11, further comprising transmitting an alarm signal to control a display module to display the alert indicator.

13. The temperature monitoring method of claim 11, further comprising displaying a normal indicator when the actual temperature value is less than or equal to the predetermined temperature value.

14. The temperature monitoring method of claim 13, further comprising transmitting a normal signal to control a display module to display the normal indicator.

15. The temperature monitoring method of claim 11, further comprising controlling an alarm module to sound alarm when the actual temperature value is greater than the predetermined temperature value.

16. The temperature monitoring method of claim 15, further comprising transmitting a control signal to control an alarm module to sound alarm.

17. The temperature monitoring method of claim 16, wherein the alarm module comprises a switch, and the switch is switched on/off by the control signal.

18. The temperature monitoring method of claim 17, wherein the switch is a transistor.

19. A temperature monitoring system comprising:
a detection module configured to detect and generate a plurality of actual temperature values;
a control module having a storage unit configured to store the plurality of actual temperature values; and
a display module coupled to the detection module via the control module, and configured to display the plurality of actual temperature values;
wherein the control any of the actual temperature values stored in the storage unit is recalled and displayed on the display module by the control module.

20. The temperature monitoring system of claim 19, wherein the control module further comprises a timing unit for measuring time; and the display module displays the time and the corresponding actual temperature value synchronously.
